(19) United States
(12) Patent Application Publication
(10) Pub. No.: US 2025/0070927 A1
(43) Pub. Date: Feb. 27, 2025

(54) MULTI-USER ORTHOGONAL FREQUENCY DIVISION MULTIPLEXING (OFDM) SUBCARRIER ALLOCATION METHOD AND APPARATUS

(71) Applicant: BEIJING XIAOMI MOBILE SOFTWARE CO.,, Beijing (CN)

(72) Inventors: Zhenyu ZHANG, Beijing (CN); Qun ZHAO, Beijing (CN); Yumin WU, Beijing (CN); Liangang CHI, Beijing (CN); Su HU, Beijing (CN); Yixan HUANG, Beijing (CN); Qibin YE, Beijing (CN); Zelin HU, Beijing (CN)

(73) Assignee: BEIJING XIAOMI MOBILE SOFTWARE CO.,, Beijing (CN)

(21) Appl. No.: 18/726,439

(22) PCT Filed: Jan. 6, 2022
(86) PCT No.: PCT/CN2022/070597

§ 371 Date: Jul. 3, 2024

(51) Int. Cl. H04L 5/00; H04W 74/0833

(52) U.S. Cl. CPC H04L 5/0007; H04L 5/0044; H04W 74/0833

(57) ABSTRACT

A method, apparatus and computer readable medium for a multi-user orthogonal frequency division multiplexing (OFDM) subcarrier allocation that improves detection performance of the integrated communication radar system. The performance of the integrated communication radar system is improved by: determining a pseudo-random subcarrier allocation manner for multi-user OFDM.

### CROSS REFERENCE TO RELATED APPLICATIONS

This application is a National Phase of International Application No. PCT/CN2022/070597, filed on Jan. 6, 2022, the entire contents of which are incorporated herein by reference in their entirety.

### TECHNICAL FIELD

The present disclosure relates to the field of communication technology, in particular to a multi-user orthogonal frequency division multiplexing (OFDM) subcarrier allocation method and apparatus, a communication device, and a storage medium.

### BACKGROUND

With the rapid development of wireless communication technology, integrated sensing and communication have been widely discussed as potential key technologies for 6G. An integrated communication radar system usually adopts a single platform to achieve both communication transmission and radar return processing functions simultaneously but usually only considers a scenario of a single user (i.e., a single data receiving terminal in the integrated communication radar system). In a multi-user scenario, when multiple users adopt the simplest subcarrier continuous allocation solution, the detection performance of the integrated communication radar system is poor.

### SUMMARY

The embodiments of the present disclosure provide a multi-user orthogonal frequency division multiplexing (OFDM) subcarrier allocation method and apparatus, a communication device, and a storage medium. By constructing a pseudo-random sequence, subcarriers are randomly allocated to users to reduce a correlation of signals from different users, thereby improving detection performance of the integrated communication radar system.

In the first aspect, embodiments of the present disclosure provide a multi-user OFDM subcarrier allocation method, performed by a data transmitting terminal, including: according to configuration information, determining a pseudo-random subcarrier allocation manner for multi-user OFDM.

Through this technical solution, the pseudo-random subcarrier allocation manner for multi-user OFDM can be determined according to the configuration information, such that subcarriers are randomly allocated to users to reduce a correlation of signals from different users, thereby improving detection performance of the integrated communication radar system.

In an embodiment, the method further includes: according to a number of subcarriers of OFDM and a number of users, determining the configuration information.

In an embodiment, the configuration information includes position indexes of subcarriers allocated to each user; and according to the number of subcarriers of OFDM and the number of users, determining the configuration information includes: according to the number of subcarriers of OFDM, obtaining a pseudo-random sequence output by a quadratic polynomial permutation (QPP) interleaver; and according to the pseudo-random sequence and the number of users, determining the position indexes of the subcarriers allocated to each user.

In an embodiment, a formula for the quadratic polynomial permutation (QPP) interleaver is represented as:

$$f ( x ) = mod ( {f}_{1} x + {f}_{2} {x}^{2} , N )$$

where N is the number of subcarriers of OFDM, N=Πₚ_{ᵢ}_{∈Γ}pᵢⁿ^{ᵢ}, Γ={2, 3, 5, 7, . . . } which is a set of prime numbers, f₁ meets mod(f₁,pᵢ)>0; f₂ meets mod(f₂,pᵢ)>0; mod is a modular operator; x is an input sequence of the QPP interleaver, and values of the x are integers ranging from 1 to N; for any set of f₁ and f₂ that satisfy a condition, f(x) is the pseudo-random sequence output by the QPP interleaver, where values of the f(x) are integers ranging from 0 to N−1, to represent the position indexes of the subcarriers allocated to each user.

In an embodiment, according to the pseudo-random sequence and the number of users, determining the position indexes of the subcarriers allocated to each user includes:
according to the number K of users, sequentially dividing N values in the pseudo-random sequence into K groups, and values in each group are the position indexes of the subcarriers allocated to the corresponding user;
where the number N of subcarriers of OFDM can be evenly divided by the number K of users, and a number of values in each of the K groups is same; or
the number N of subcarriers of OFDM cannot be evenly divided by the number K of users, and a number of values in each of first a groups of the K groups is same, and a number of values in each of other groups is same, and the number of values in each of the first a groups is 1 more than the number of values in each of the other groups, where the a is a modular value of the number N of subcarriers of OFDM to the number K of users.

Through this technical solution, the pseudo-random sequence can be generated according to the number of subcarriers of OFDM, such that subcarriers are randomly allocated to users to reduce a correlation of signals from different users, thereby improving detection performance of the integrated communication radar system.

In an embodiment, the configuration information is configured by the network device or a core network device, agreed on by a protocol, or pre-configured.

In an embodiment, the method further includes: transmitting the pseudo-random subcarrier allocation manner for multi-user OFDM to a data receiving terminal and/or a return signal receiving terminal.

In an embodiment, the pseudo-random subcarrier allocation manner is associated with a specific time frequency resource, where the pseudo-random subcarrier allocation manner is used on an associated time frequency resource.

In an embodiment, the pseudo-random subcarrier allocation manner used on the associated time frequency resource is fixed; or the pseudo-random subcarrier allocation manner used on the associated time frequency resource randomly changes in time-domain positions within a plurality of OFDM symbol times.

Through this technical solution, the pseudo-random sequence can be used in a plurality of OFDM symbol times, such that subcarriers are randomly allocated to users to further reduce a correlation of signals from different users, thereby further improving the detection performance of the integrated communication radar system.

In the second aspect, the present disclosure provides a multi-user orthogonal frequency division multiplexing (OFDM) subcarrier allocation method, performed by a data receiving terminal, including: according to configuration information, determining a pseudo-random subcarrier allocation manner for the data receiving terminal.

In an embodiment, the configuration information is configured by a network device or a core network device, agreed on by a protocol, or pre-configured; or the configuration information is configuration information of the pseudo-random subcarrier allocation manner for multi-user OFDM transmitted by a data transmitting terminal.

In an embodiment, the configuration information includes position indexes of subcarriers allocated to each user.

Through this technical solution, subcarriers can be randomly allocated to the data receiving terminals to reduce a correlation of signals from different users, thereby improving detection performance of the integrated communication radar system.

In the third aspect, the present disclosure provides a multi-user orthogonal frequency division multiplexing (OFDM) subcarrier allocation method, performed by a return signal receiving terminal, including: according to configuration information, determining a pseudo-random subcarrier allocation manner for the return signal receiving terminal.

In an embodiment, the configuration information is configured by a network device or a core network device, agreed on by a protocol, or pre-configured; or the configuration information is configuration information of the pseudo-random subcarrier allocation manner for multi-user OFDM transmitted by a data transmitting terminal.

In an embodiment, the configuration information includes position indexes of subcarriers allocated to each user.

Through this technical solution, subcarriers can be randomly allocated to the return signal receiving terminals to reduce a correlation of signals from different users, thereby improving detection performance of the integrated communication radar system.

In the fourth aspect, the present disclosure provides a multi-user OFDM subcarrier allocation apparatus, applied to a data transmitting terminal, including:

a first processing module, configured to, according to configuration information, determine a pseudo-random subcarrier allocation manner for multi-user OFDM.

In an embodiment, the apparatus further includes a second processing module, configured to, according to a number of subcarriers of OFDM and a number of users, determine the configuration information.

In an embodiment, the configuration information includes position indexes of subcarriers allocated to each user, and the second processing module is configured to: according to the number of subcarriers of OFDM, obtaining a pseudo-random sequence output by a quadratic polynomial permutation (QPP) interleaver; and according to the pseudo-random sequence and the number of users, determining the position indexes of the subcarriers allocated to each user.

In an embodiment, a formula for the quadratic polynomial permutation (QPP) interleaver is represented as:

$$f ( x ) = mod ( {f}_{1} x + {f}_{2} {x}^{2} , N )$$

where N is the number of subcarriers of OFDM, N=Πₚ_{ᵢ}_{∈Γ}pᵢⁿ^{ᵢ}, Γ={2, 3, 5, 7, . . . } which is a set of prime numbers, fᵢ meets mod(f₁,pᵢ)>0; f₂ meets mod(f₂,pᵢ)>0; mod is a modular operator; x is an input sequence of the QPP interleaver, and values of the x are integers ranging from 1 to N; for any set of f₁ and f₂ that satisfy a condition, f(x) is the pseudo-random sequence output by the QPP interleaver, where values of the f(x) are integers ranging from 0 to N−1, to represent the position indexes of the subcarriers allocated to each user.

In an embodiment, according to the pseudo-random sequence and the number of users, determining the position indexes of the subcarriers allocated to each user includes:
according to the number K of users, sequentially dividing N values in the pseudo-random sequence into K groups, and values in each group are the position indexes of the subcarriers allocated to the corresponding user;
where the number N of subcarriers of OFDM can be evenly divided by the number K of users, and a number of values in each of the K groups is same; or
the number N of subcarriers of OFDM cannot be evenly divided by the number K of users, and a number of values in each of first a groups of the K groups is same, and a number of values in each of other groups is same, and the number of values in each of the first a groups is 1 more than the number of values in each of the other groups, where the a is a modular value of the number N of subcarriers of OFDM to the number K of users.

In an embodiment, the configuration information is configured by the network device or a core network device, agreed on by a protocol, or pre-configured.

In an embodiment, the apparatus further includes a transmitting module, configured to transmit the pseudo-random subcarrier allocation manner for multi-user OFDM to a data receiving terminal and/or a return signal receiving terminal.

In an embodiment, the pseudo-random subcarrier allocation manner is associated with a specific time frequency resource, where the pseudo-random subcarrier allocation manner is used on an associated time frequency resource.

In an embodiment, the pseudo-random subcarrier allocation manner used on the associated time frequency resource is fixed; or the pseudo-random subcarrier allocation manner used on the associated time frequency resource randomly changes in time-domain positions within a plurality of OFDM symbol times.

In the fifth aspect, the present disclosure provides a multi-user OFDM subcarrier allocation apparatus, applied to a data receiving terminal, including a processing module configured to, according to configuration information, determine a pseudo-random subcarrier allocation manner for the data receiving terminal.

In an embodiment, the configuration information is configured by a network device or a core network device, agreed on by a protocol, or pre-configured; or the configuration information is configuration information of the pseudo-random subcarrier allocation manner for multi-user OFDM transmitted by a data transmitting terminal.

In an embodiment, the configuration information includes position indexes of subcarriers allocated to each user.

In the sixth aspect, the present disclosure provides a multi-user OFDM subcarrier allocation apparatus, applied to a return signal receiving terminal, including a processing module configured to, according to configuration information, determining a pseudo-random subcarrier allocation manner for the return signal receiving terminal.

In an embodiment, the configuration information is configured by a network device or a core network device, agreed on by a protocol, or pre-configured; or the configuration information is configuration information of the pseudo-random subcarrier allocation manner for multi-user OFDM transmitted by a data transmitting terminal.

In an embodiment, the configuration information includes position indexes of subcarriers allocated to each user.

In the seventh aspect, the present disclosure provides a communication device, including one or more processors and one or more memories, where a computer program is stored in the one or more memories, and the one or more processors execute the computer program stored in the one or more memories to enable the terminal device to execute the method according to the first aspect.

In the eighth aspect, the present disclosure provides a communication device, including one or more processors and one or more memories, where a computer program is stored in the one or more memories, and the one or more processors execute the computer program stored in the one or more memories to enable the terminal device to execute the method according to the second aspect.

In the ninth aspect, the present disclosure provides a communication device, including one or more processors and one or more memories, where a computer program is stored in the one or more memories, and the one or more processors execute the computer program stored in the one or more memories to enable the terminal device to execute the method according to the third aspect.

In the tenth aspect, the present disclosure provides a computer-readable storage medium storing instructions, where when the instructions are executed, the method according to the first aspect is implemented.

In the eleventh aspect, the present disclosure provides a computer-readable storage medium storing instructions, where when the instructions are executed, the method according to the second aspect is implemented.

In the twelfth aspect, the present disclosure provides a computer-readable storage medium storing instructions, where when the instructions are executed, the method according to the third aspect is implemented.

In the thirteenth aspect, the present disclosure provides a computer program product including a computer program, where when the computer program is executed by one or more processors, the method according to the first aspect is implemented.

In the fourteenth aspect, the present disclosure provides a computer program product including a computer program, where when the computer program is executed by one or more processors, the method according to the second aspect is implemented.

In the fifteenth aspect, the present disclosure provides a computer program product including a computer program, where when the computer program is executed by one or more processors, the method according to the third aspect is implemented.

### BRIEF DESCRIPTION OF DRAWINGS

In order to provide a clearer explanation of technical solutions in the embodiments or background technology of the present disclosure, accompanying drawings used in the embodiments or background technology of the present disclosure will be explained below.

FIG. 1 is a schematic architecture diagram of an integrated communication radar system provided in embodiments of the present disclosure.

FIG. 2 is a schematic architecture diagram of an OFDM-based integrated communication radar system provided in embodiments of the present disclosure.

FIG. 3 is a flowchart of a multi-user OFDM subcarrier allocation method provided in embodiments of the present disclosure.

FIG. 4 is a flowchart of another multi-user OFDM subcarrier allocation method provided in embodiments of the present disclosure.

FIG. 5 is a flowchart of still another multi-user OFDM subcarrier allocation method provided in embodiments of the present disclosure.

FIG. 6a is a user time-frequency domain resource image provided in embodiments of the present disclosure.

FIG. 6b is another user time-frequency domain image diagram provided in embodiments of the present disclosure.

FIG. 7a is a user radar image provided in embodiments of the present disclosure.

FIG. 7b is another user radar image provided in embodiments of the present disclosure.

FIG. 8 is still another user radar image provided in embodiments of the present disclosure.

FIG. 9 is a flowchart of still another multi-user OFDM subcarrier allocation method provided in embodiments of the present disclosure.

FIG. 10 is a flowchart of still another multi-user OFDM subcarrier allocation method provided in embodiments of the present disclosure.

FIG. 11 is a schematic structural diagram of a multi-user OFDM subcarrier allocation apparatus provided in embodiments of the present disclosure.

FIG. 12 is a schematic structural diagram of another multi-user OFDM subcarrier allocation apparatus provided in embodiments of the present disclosure.

FIG. 13 is a schematic structural diagram of still another multi-user OFDM subcarrier allocation apparatus provided in embodiments of the present disclosure.

FIG. 14 is a schematic structural diagram of still another multi-user OFDM subcarrier allocation apparatus provided in embodiments of the present disclosure.

FIG. 15 is a schematic structural diagram of still another multi-user OFDM subcarrier allocation apparatus provided in embodiments of the present disclosure.

FIG. 16 is a schematic structural diagram of a communication device provided in embodiments of the present disclosure.

### DETAILED DESCRIPTION

The following describes in detail the embodiments of the present disclosure, examples of the embodiments are shown in the accompanying drawings, where identical or similar labels throughout represent identical or similar components or components with identical or similar functions. The embodiments described below with reference to the accompanying drawings are exemplary and intended to explain the present disclosure, but cannot be understood as limiting the present disclosure.

In order to better understand the multi-user Orthogonal Frequency Division Multiplexing (OFDM) subcarrier allocation method disclosed in embodiments of the present disclosure, the following will first describe the integrated communication radar system used in embodiments of the present disclosure.

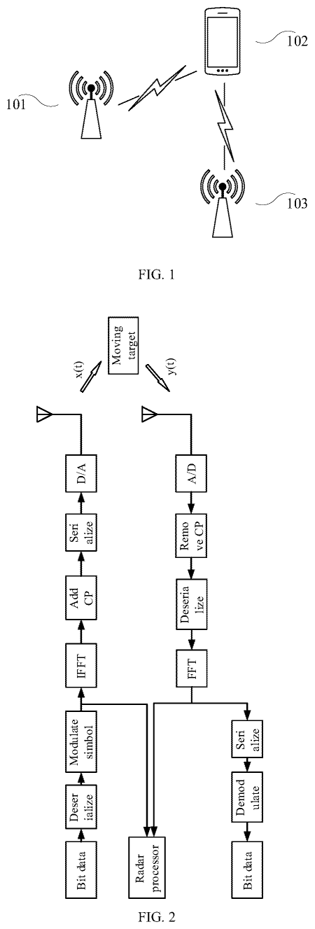

Referring to FIG. 1, FIG. 1 is a schematic architecture diagram of an integrated communication radar system provided in embodiments of the present disclosure. The integrated communication radar system can include but is not limited to one data transmitting terminal, one data receiving terminal, and one return signal receiving terminal. The number and form of devices shown in FIG. 1 are only for illustrative purposes and do not constitute limitations to the embodiments of the present disclosure. In practical applications, two or more data transmitting terminals, two or more data receiving terminals, and two or more return signal receiving terminals can be included. The communication system shown in FIG. 1 includes one data transmitting terminal 101, one data receiving terminal 102, and one return signal receiving terminal 103 as an example.

The data transmitting terminal 101 and the return signal receiving terminal 103 in the embodiments of the present disclosure are entities configured to transmit or receive signals. For example, the data transmitting terminal 101 can be an evolved NodeB (eNB), a transmission reception point (TRP), a next generation NodeB (gNB) in an NR system, base stations in other future mobile communication systems, or access nodes in wireless fidelity (WiFi) systems. The embodiments of the present disclosure do not limit the specific technology and device form adopted by the data transmitting terminal. The data transmitting terminal provided in the embodiments of the present disclosure can be composed of a central unit (CU) and a distributed unit (DU), where the CU can also be referred to as a control unit. The data transmitting terminal can divide, such as, protocol layers of the base station by using the CU-DU structure, where functions of some protocol layers are distributed in the CU and centrally controlled, and a part of or all of the functions of the remaining protocol layers are distributed in the DU, where the DU is centrally controlled by the CU. Alternatively, the data transmitting terminal 101 and the return signal receiving terminal 103 may also be entities of the same type as the following data receiving terminal 102, configured to receive or transmit signals.

The data receiving terminal 102 in the embodiments of the present disclosure is an entity for receiving or transmitting signals on the user side, such as a mobile phone. The data receiving terminal can also be referred to as a terminal, a user equipment (UE), a mobile station (MS), or a mobile terminal (MT). The data receiving terminal can include a car, a smart car, a mobile phone, a wearable device, a pad, a computer with a wireless transmission and reception capability, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation security, a wireless terminal device in smart city, or a wireless terminal device in smart home, that has a communication capability.

It should be noted that the return signal receiving terminal 103 in the embodiments of the present disclosure is a device for amplifying, transforming, and processing a return signal. It can be understood that the application scenarios of integrated communication radar systems can be divided into two types according to the nature of a radar, that is, active radar systems and passive radar systems.

Referring to FIG. 2, FIG. 2 is a schematic architecture diagram of an OFDM-based integrated communication radar system provided in embodiments of the present disclosure. As shown in FIG. 2, the data transmitting terminal transmits bit data that needs to be transmitted after a series of modulation processing. The signal transmitted by the data transmitting terminal is reflected by a target and received by the data receiving terminal. The data receiving terminal demodulates the received signal to obtain the original bit data transmitted by the data transmitting terminal. At the same time, a return receiving terminal (i.e., a radar processor) can determine position information of a moving target according to the received signal. It can simultaneously achieve the communication function between the data transmitting terminal and the data receiving terminal, and the radar function for detecting the moving target's position.

In an active radar system, the data transmitting terminal and the return signal receiving terminal are the same device. The data transmitting terminal transmits bit data to the data receiving terminal, and the data receiving terminal acts as a receiver to complete the communication function. The bit data transmitted by the data transmitting terminal irradiates the data receiving terminal to generate a return signal, and the return signal is transmitted back to the return signal receiving terminal (i.e., the data transmitting terminal). The return signal receiving terminal detects the speed and position information of the data receiving terminal through the radar processor, thereby completing the radar function. The data transmitting terminal, the data receiving terminal, and the return signal receiving terminal can be:
(1) The data transmitting terminal and the return signal receiving terminal are a Base Station (BS), and the data receiving terminal is a UE; or
(2) The data transmitting terminal and the return signal receiving terminal are a UE 1, and the data receiving terminal is a UE 2.

In a passive radar system, the data transmitting terminal and the return signal receiving terminal are different devices, and there can be a plurality of return signal receiving terminals. The bit data transmitted by the data transmitting terminal irradiates the data receiving terminal to generate a return signal, and the return signal is transmitted back to the return signal receiving terminal(s). The return signal receiving terminal detects the speed and position information of the data receiving terminal through the radar processor, thereby completing the radar function. The data transmitting terminal, the data receiving terminal, and the return signal receiving terminal can be:
(1) The data transmitting terminal is a BS 1, the data receiving terminal is a UE, and the return signal receiving terminal is a BS 2 or a set of BSs {BS 2, BS 3, . . . , BS n};
(2) The data transmitting terminal is a UE 1, the data receiving terminal is a UE 2, and the return signal receiving terminal is a UE 3 or a set of UEs {UE 3, UE 4, . . . , UE k};
(3) The data transmitting terminal is a UE 1, the data receiving terminal is a UE 2, and the return signal receiving terminal is a BS 1 or a set of BSs {BS 1, BS 2, . . . , BS n}; or
(4) The data transmitting terminal is a BS, the data receiving terminal is a UE 1, and the return signal receiving terminal is a UE 2 or a set of UEs {UE 3, UE 4, . . . , UE k}.

From the above situation, it can be seen that both the network side and the terminal side can act as transmitting sources to transmit sensing signals.

It should be noted that in the multi-user OFDM subcarrier allocation method in embodiments of the present disclosure, each user represents a data receiving terminal in an integrated communication radar system.

The embodiments of the present disclosure do not limit the specific techniques and device forms adopted by the data transmitting terminal, data receiving terminal, and return signal receiving terminal.

It can be understood that the communication system described in the embodiments of the present disclosure is intended to provide a clearer explanation of the technical solutions in the embodiments of the present disclosure, and does not constitute a limitation on the technical solutions provided in the embodiments of the present disclosure. As those skilled in the art know, with the evolution of the system architecture and the emergence of new business scenarios, the technical solutions provided in the embodiments of the present disclosure are also applicable to similar technical problems.

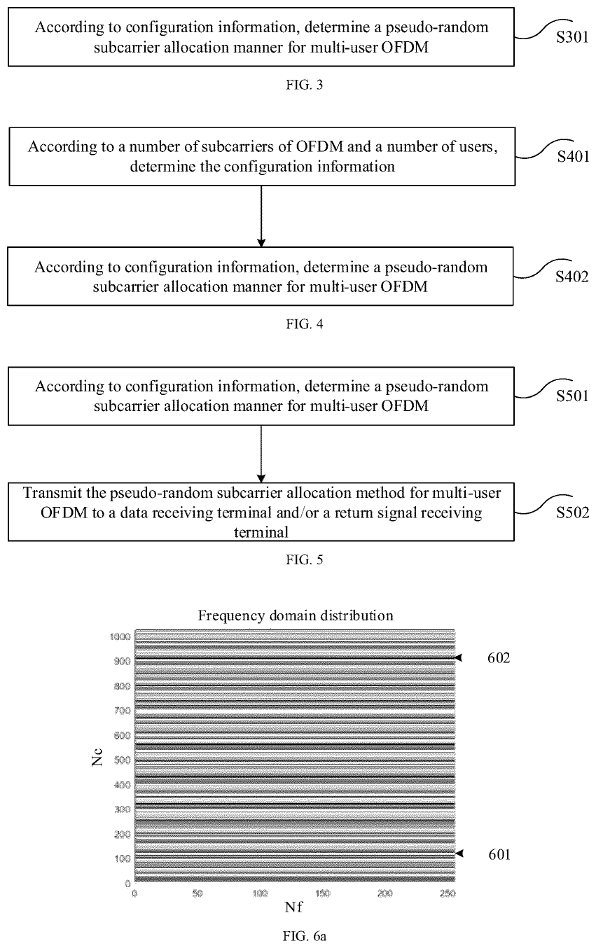

The following provides a detailed introduction to the multi-user OFDM subcarrier allocation method and apparatus, the communication device, and the storage medium provided in the present disclosure, in conjunction with the accompanying drawings. Referring to FIG. 3, FIG. 3 is a flowchart of a multi-user OFDM subcarrier allocation method provided in embodiments of the present disclosure. The method is performed by the data transmitting terminal. As shown in FIG. 3, the multi-user OFDM subcarrier allocation method may include the following step S301.

In step S301, according to configuration information, a pseudo-random subcarrier allocation manner for multi-user OFDM is determined.

Where the configuration information is configured by the network device or a core network device, agreed on by a protocol, or pre-configured.

### Example 1

according to configuration information configured by the network device, a pseudo-random subcarrier allocation manner for multi-user OFDM is determined.

The configuration information can be transmitted to the data transmitting terminal by the network device through static, and/or semi-static signaling.

For example, the network device can transmit the configuration information through radio resource control (RRC) signaling that includes cell specific, UE group common, or UE specific RRC signaling. The data transmitting terminal receives RRC signaling and determines the subcarrier allocation manner according to the configuration information in the RRC signaling. Alternatively, the network device can pre-configure a set of subcarrier allocation manners and transmit configuration information to the data transmitting terminal through media access control (MAC)—control element (CE) or downlink control information (DCI) signaling. The data transmitting terminal determines the subcarrier allocation manner according to the received configuration. Alternatively, the network device can simultaneously transmit configuration information to the data transmitting terminal through the above methods, and after the data transmitting terminal receives the configuration information, the data transmitting terminal can independently choose a subcarrier allocation manner according to the situation.

### Example 2

according to configuration information configured by the core network device, a pseudo-random subcarrier allocation manner for multi-user OFDM is determined.

The configuration information can be transmitted to the data transmitting terminal by a core network device through static, and/or semi-static signaling.

The core network device transmits the configuration information to the data transmitting terminal through static, and/or semi-static signaling, which can be implemented through any one of the embodiments of the present disclosure, which is not limited and repeated in the embodiments of the present disclosure.

### Example 3

according to configuration information agreed on by a protocol, a pseudo-random subcarrier allocation manner for multi-user OFDM is determined.

For example, configuration information corresponding to a plurality of pseudo-random subcarrier allocation manners for multi-user OFDM can be pre-determined through one or more protocols, and the data transmitting terminal can independently choose the appropriate subcarrier allocation manner.

### Example 4

according to configuration information pre-configured, a pseudo-random subcarrier allocation manner for multi-user OFDM is determined.

For example, configuration information corresponding to a plurality of pseudo-random subcarrier allocation manners for multi-user OFDM can be pre-configured, and the data transmitting terminal can independently choose the appropriate subcarrier allocation manner.

Through embodiments of the present disclosure, the pseudo-random subcarrier allocation manner for multi-user OFDM can be determined according to the configuration information, such that subcarriers are randomly allocated to users to reduce a correlation of signals from different users, thereby improving detection performance of the integrated communication radar system.

Referring to FIG. 4, FIG. 4 is a flowchart of another multi-user OFDM subcarrier allocation method provided in embodiments of the present disclosure. The method can determine the configuration information for subcarrier allocation for multi-user OFDM. In some embodiments of the present disclosure, as shown in FIG. 4, the multi-user OFDM subcarrier allocation method may include the following steps S401 to S402.

In step S401, according to a number of subcarriers of OFDM and a number of users, the configuration information is determined.

The configuration information includes position indexes of subcarriers allocated to each user.

In the embodiments of the present disclosure, the position indexes of the subcarriers allocated to each user are for indicating frequency-domain positions of the subcarriers allocated to the user.

In an embodiment, according to the number of subcarriers of OFDM, a Quadratic Polynomial Permutation (QPP) interleaver is used to output a pseudo-random sequence; and according to the pseudo-random sequence and the number of users, the position indexes of the subcarriers allocated to each user can be determined.

In an embodiment, a formula for the quadratic polynomial permutation (QPP) interleaver is represented as:

$$f ( x ) = mod ( {f}_{1} x + {f}_{2} {x}^{2} , N )$$

where N is the number of subcarriers of OFDM, N=Πₚ_{ᵢ}_{∈Γ}pᵢⁿ^{ᵢ}, Γ={2, 3, 5, 7, . . . } which is a set of prime numbers, fᵢ meets mod(f₁,pᵢ)>0; f₂ meets mod(f₂,pᵢ)>0; mod is a modular operator; x is an input sequence of the QPP interleaver, and values of the x are integers ranging from 1 to N; for any set of f₁ and f₂ that satisfy a condition, f(x) is the pseudo-random sequence output by the QPP interleaver, where values of the f(x) are integers ranging from 0 to N−1, to represent the position indexes of the subcarriers allocated to each user. It can be understood that x is a sequence composed of N integers from 1 to N. x is inputted to QPP to obtain f(x). The output f(x) is a pseudo-random sequence composed of N integers from 0 to N−1. The pseudo-random sequence contains the position indexes of the subcarriers allocated to each user.

It should be noted that the present disclosure, under a continuous subcarrier allocation manner, improves the allocation manner by adopting a random allocation manner. Due to the inability to design true randomness in hardware implementation, a pseudo-random sequence is introduced to randomly allocate subcarrier positions for multiple users. In the present disclosure, Γ={2, 3, 5, 7, . . . } represents a set of prime numbers. The integer N can be decomposed into

$$N = {\prod }_{p ∈ Γ} {p}^{{n}_{N , p}} ,$$

where p represents different prime numbers. For each determined p, n_{N,p}≥1, otherwise, n_{N,p}=0. For an integer N≥2 and a polynomial f(x)=mod(Σᵢ₌₁^{K}fᵢxⁱ, N), where f₁, f₂, . . . , f_{K} are non-negative integers and K≥1, when f(x) is sorted according to {0, 1, . . . , N−1}, f(x) is called a permutation polynomial based on integers Z_{N}. The formula for the QPP interleaver can be inferred according to Theorem 1 and Theorem 2.

Theorem 1: For any

$$N = {\prod }_{p ∈ Γ} {p}^{{n}_{N , p}} ,$$

if and only if

$$f ( x ) = mod ( {f}_{1} x + {f}_{2} {x}^{2} , {p}^{{n}_{N , p}} )$$

is QPP for any prime factor p where n_{N,p}≥1, f(x)=mod(f₁x+f₂x², N) is QPP.

In Theorem 1, pⁿ^{_{N,p}} is the factor of N. By utilizing the above theorem, it can be determined whether a polynomial is a polynomial permutation (PP) on a module N. For a quadratic polynomial on an integer ring, the following theorem can be obtained.

Theorem 2: For a quadratic polynomial f(x)=f₁x+f₂x², where p is any prime number and n≥2, if and only if f₁≠mod(0,p) and f₂=mod(0,p), it is called a QPP according to an integer ring Z_{P}_{ⁿ}.

According to Theorem 1 and Theorem 2, the following inference can be drawn:

Inference: If and only if for any i, there is mod(f₁,pᵢ)>0 and mod(f₂,pᵢ)=0, f(x) is called QPP on a module

$$N = {\prod }_{p ∈ Γ} {p}^{{n}_{N , p}} .$$

For example, when the number of subcarriers of OFDM is N=1024, f₁ meeting the condition of the above inference can take all positive odd numbers, and f₂ meeting the above inference conditions can take all positive even numbers.

In an embodiment, according to the pseudo-random sequence and the number of users, the implementation for determining the position indexes of the subcarriers allocated to each user can be as follows: according to the number K of users, the N values in the pseudo-random sequence are sequentially divided into K groups, and the values in each group are the position indexes of the subcarriers allocated to the corresponding user, where the number N of subcarriers of OFDM can be evenly divided by the number K of users, and the number of values contained in each of the K group is the same; or the number N of subcarriers of OFDM cannot be evenly divided by the number K of users, and the number of values in each of first a groups of the K groups is same, and the number of values in each of other groups is same, and the number of values in each of the first a groups is 1 more than the number of values in each of the other groups, where the a is a modular value of the number N of subcarriers of OFDM to the number K of users.

In an embodiment, assuming that the number of users is K, a=mod(N,K),

$$b = ⌊ \frac{N}{K} ⌋ ,$$

where b is the value obtained by rounding down the quotient of N and K, in response to a=0, which represents that the number N of subcarriers of OFDM can be evenly divided by the number K of users, the position indexes of the subcarriers allocated to the k-th user are respectively f(x) where x=(k−1)b+1, . . . , kb and 1≤k≤K, and the number of values for the position indexes of the subcarriers allocated to each user is the same; or in response to a>0, which represents that the number N of subcarriers of OFDM cannot be evenly divided by the number K of users, if 1≤k≤a, the position indexes of the subcarriers allocated to the k-th user are respectively f(x) where x=(k−1)(b+1)+1, . . . , k(b+1), and if a<k≤K, the position indexes of the subcarriers allocated to the k-th user are f(x) where x=(k−a−1)b+a(b+1)+1, . . . , (k−a)b+a(b+1), where the number of position indexes of the subcarriers allocated to each of the users who meet the conditions and are in the front of a sequence is 1 more than the number of position indexes of the subcarriers allocated to the users who do not meet the conditions and are in the rear of the sequence.

For example, after the number of subcarriers of OFDM and the number of users are determined, according to the above formula, corresponding values of x can be sequentially allocated to each user. By inputting the values of x allocated to each user and values of N, f₁ and f₂ to the QPP formula, the position indexes of the subcarriers allocated to each user can be obtained.

As an example, when the number of subcarriers of OFDM N=1024 and the number of users K=4 i.e., including four users 1, 2, 3 and 4, a=mod(N,K)=mod(1024,4)=0 represents that the number N of subcarriers of OFDM can be evenly divided by the number K of users,

$$b = ⌊ \frac{N}{K} ⌋ = ⌊ \frac{1024}{4} ⌋ = 256 ,$$

and by substituting k=1 and b=256 into the formula x=(k−1)b+1, . . . , kb, the position indexes of the subcarriers allocated to the first user are respectively [f(1), f(2), f(3) . . . f(256)]. In this case, the number of the position indexes of the subcarriers allocated to each user is the same.

As another example, when the number of subcarriers of OFDM N=1026 and the number of users K=4, i.e., including four users 1, 2, 3 and 4, a=mod(N,K)=mod(1024,4)=2 represents that the number N of subcarriers of OFDM cannot be evenly divided by the number K of users,

$$b = ⌊ \frac{N}{K} ⌋ = ⌊ \frac{1026}{4} ⌋ = 256 ,$$

the first user satisfies 1≤1≤2, and by substituting k=1 and b=256 into the formula x=(k−1)(b+1)+1, . . . , k(b+1), the position indexes of the subcarriers allocated to the first user are respectively [f(1), f(2), f(3) . . . f(256), f(257)], with a total of 257 position indexes of subcarriers. The third user satisfies 2<3≤4, and by substituting k=3 and b=256 into the formula x=(k−a−1)b+a(b+1)+1, . . . , (k−a)b+a(b+1), the position indexes of the subcarriers allocated to the third user are respectively [f(515), f(516), f(517) . . . f(770)], with a total of 256 position indexes of subcarriers. In this case, the number of position indexes of the subcarriers contained in each of the first two groups corresponding to the first two users who meet the condition is 1 more than the number of position indexes of the subcarriers contained in each of the last two groups corresponding to the last two users who do not meet the condition.

As another example, when the number of subcarriers in OFDM is 1024, taking f₁=1 and f₂=16, users 1, 2, 3, and 4 each occupy 256 subcarriers. According to the above allocation manner, one of the values of 256 x allocated to the first user is x=20. By instituting N=1024, f₁=1, f₂=16 and x=20 into the QPP formula, f(20)=276. Therefore, one available subcarrier for the first user is the 277-th subcarrier. By sequentially instituting all the values of x allocated to the first user, the position indexes of all subcarriers for the first user can be obtained.

In step S402, according to configuration information, a pseudo-random subcarrier allocation manner for multi-user OFDM is determined.

In the embodiments of the present disclosure, step S402 can be implemented through any one of the embodiments of the present disclosure, which is not limited and repeated in the embodiments of the present disclosure.

By implementing the embodiments of the present disclosure, the pseudo-random sequence can be generated according to the number of OFDM subcarriers, such that subcarriers are randomly allocated to users to reduce a correlation of signals from different users, thereby improving detection performance of the integrated communication radar system.

Referring to FIG. 5, FIG. 5 is a flowchart of a multi-user OFDM subcarrier allocation method provided in embodiments of the present disclosure. The method can transmit the subcarrier pseudo-random allocation manner to the data receiving terminal and/or return signal receiving terminal in the same integrated communication radar system. As shown in FIG. 5, the multi-user OFDM subcarrier allocation method may include the following steps S501 to S502.

In step S501, according to configuration information, a pseudo-random subcarrier allocation manner for multi-user OFDM is determined.

In the embodiments of the present disclosure, step S501 can be implemented through any one of the embodiments of the present disclosure, which is not limited and repeated in the embodiments of the present disclosure.

In step S502, the pseudo-random subcarrier allocation method for multi-user OFDM is transmitted to a data receiving terminal and/or a return signal receiving terminal.

For example, after the pseudo-random subcarrier allocation manner for multi-user OFDM is determined through any of the above methods, the data transmitting terminal can transmit the subcarrier allocation manner to the data receiving terminal and/or the return signal receiving terminal through control signaling.

In an embodiment, the pseudo-random subcarrier allocation manner is associated with a specific time frequency resource, where the pseudo-random subcarrier allocation manner is used on an associated time frequency resource.

For example, on available frequency-domain resources at a specific time, subcarriers can be allocated to multiple users using the pseudo-random allocation manner provided in any embodiment of the present disclosure.

In an embodiment, the pseudo-random subcarrier allocation manner used on the associated time frequency resource is fixed; or the pseudo-random subcarrier allocation manner used on the associated time frequency resource randomly changes in time-domain positions within a plurality of OFDM symbol times.

For example, using the pseudo-random allocation manner provided in any embodiment of the present disclosure, after the available subcarrier positions is allocated to each user, the available subcarrier positions for each user remain fixed and unchanged over a continuous period of an available time resource; or a period of available time resources can be divided into multiple OFDM symbol times, and within each OFDM symbol time, a pseudo-random allocation method provided in any embodiment of the present disclosure can be used to re-allocate different subcarrier positions to each user, causing changes in the available subcarriers for each user at different OFDM symbol times.

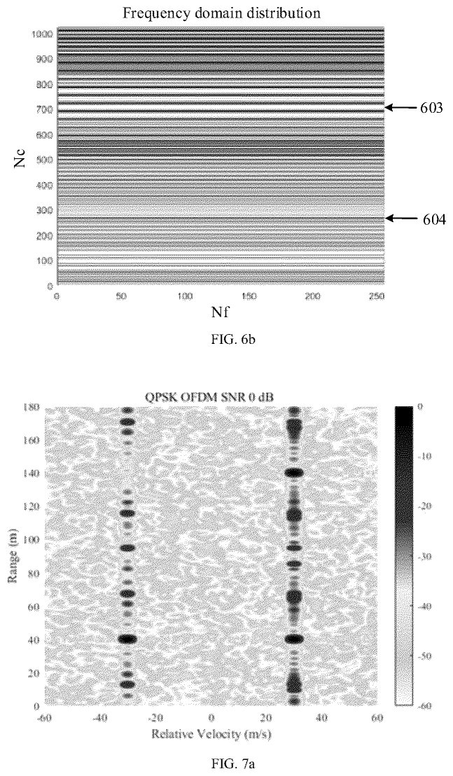

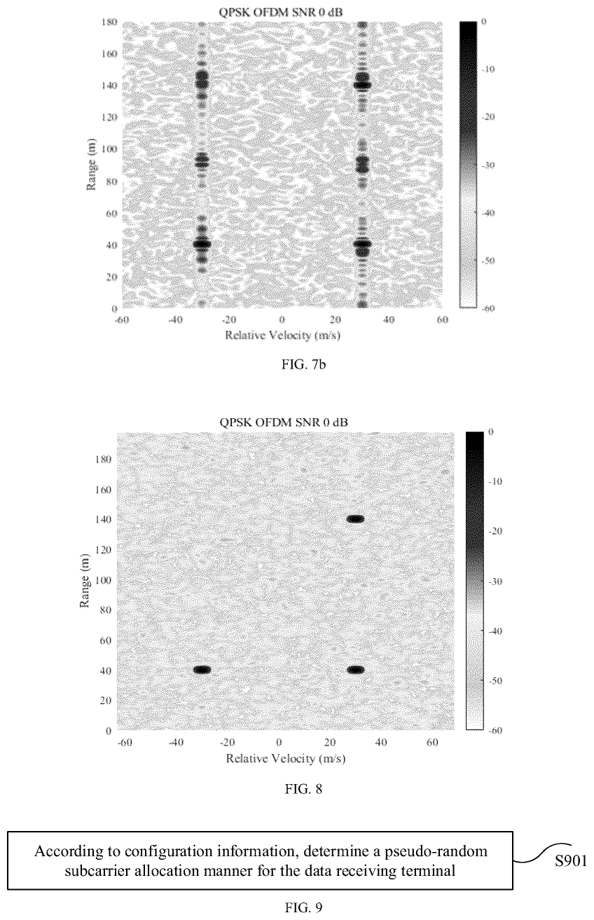

As an example, there are four users 1, 2, 3 and 4, and each user occupies 256 of 1024 subcarriers within 256 OFDM symbol times. The subcarrier positions for each user are pseudo-randomly allocated using the pseudo-random sequence output by the QPP interleaver provided in embodiments of the present disclosure, and the subcarrier positions within 256 OFDM symbol times for each user remain unchanged. Referring to FIGS. 6a and 6b, as shown in FIG. 6a, FIG. 6a is the time-frequency resource image for User 1 when the selected parameters are f₁=15 and f₂=32, and as shown in FIG. 6b, FIG. 6b is the time-frequency resource image for User 1 when the selected parameters are f₁=1 and f₂=16. In FIG. 6, the white parts indicated by arrows 601 and 603, and the other white parts in the figure represent the subcarriers occupied by user 1. The black parts indicated by arrows 602 and 604, and the other black parts in the figure represent the subcarriers not occupied by user 1. Referring to FIGS. 7a and 7b, as shown in FIG. 7a, FIG. 7a is the radar image for User 1 when the selected parameters are f₁=15 and f₂=32, and as shown in FIG. 7b. FIG. 7b is the radar image for User 1 when the selected parameters are f₁=1 and f₂=16. From FIGS. 7a and 7b, it can be seen that regardless of the selected parameters, the sidelobes of the radar detection image are more obvious, indicating poor detection performance.

As another example, assuming that there are four users 1, 2, 3 and 4, each occupying 256 of 1024 subcarriers within 256 OFDM symbol times. At different OFDM symbol times, subcarrier positions of each user are pseudo-randomly allocated using the pseudo-random sequence output by the QPP interleaver provided in embodiments of the present disclosure. On the time-frequency domain resource image, the subcarriers occupied by a single user are represented as discrete point shapes. Referring to FIG. 8, as shown in FIG. 8, FIG. 8 is a schematic diagram of the radar detection image for User 1 when the available subcarriers for each user change at different OFDM symbol times. It can be seen from the figure that User 1 can clearly distinguish the other three users, and the detection effect is significantly better than the situation where the positions of the available subcarriers for each user remains fixed.

By implementing the embodiments of the present disclosure, the pseudo-random sequence can be used in a plurality of OFDM symbol times, such that subcarriers are randomly allocated to users to further reduce a correlation of signals from different users, thereby further improving detection performance of the integrated communication radar system.

Referring to FIG. 9, FIG. 9 is a flowchart of a multi-user OFDM subcarrier allocation method provided in embodiments of the present disclosure. The method is performed by a data receiving terminal. As shown in FIG. 9, the multi-user OFDM subcarrier allocation method may include the following step S901.

In step S901, according to configuration information, a pseudo-random subcarrier allocation manner for the data receiving terminal is determined.

Where the configuration information is configured by a network device or a core network device, agreed on by a protocol, or pre-configured; or the configuration information is configuration information of the pseudo-random subcarrier allocation manner for multi-user OFDM transmitted by a data transmitting terminal.

In the embodiments of the present disclosure, step S901 can be implemented through any one of the embodiments of the present disclosure, which is not limited and repeated in the embodiments of the present disclosure.

In an embodiment, the configuration information includes position indexes of subcarriers allocated to each user.

For example, the data receiving terminal can determine the frequency domain positions of available subcarriers according to the position indexes of subcarriers in the configuration information.

By implementing the embodiments of the present disclosure, subcarriers can be randomly allocated to the data receiving terminals to reduce a correlation of signals from different users, thereby improving detection performance of the integrated communication radar system.

Referring to FIG. 10, FIG. 10 is a flowchart of a multi-user OFDM subcarrier allocation method provided in embodiments of the present disclosure. The method is executed by a return signal receiving terminal. As shown in FIG. 10, the multi-user OFDM subcarrier allocation method may include the following step S1001.

In step S1001, according to configuration information, a pseudo-random subcarrier allocation manner for the return signal receiving terminal is determined.

Where the configuration information is configured by a network device or a core network device, agreed on by a protocol, or pre-configured; or the configuration information is configuration information of the pseudo-random subcarrier allocation manner for multi-user OFDM transmitted by a data transmitting terminal.

In the embodiments of the present disclosure, step S1001 can be implemented through any one of the embodiments of the present disclosure, which is not limited and repeated in the embodiments of the present disclosure.

In an embodiment, the configuration information includes position indexes of subcarriers allocated to each user.

For example, the return signal receiving terminal can determine the frequency domain positions of available subcarriers according to the position indexes of subcarriers in the configuration information.

By implementing the embodiments of the present disclosure, subcarriers can be randomly allocated to the return signal receiving terminals to reduce a correlation of signals from different users, thereby improving detection performance of the integrated communication radar system.

Referring to FIG. 11, FIG. 11 is a schematic diagram of a multi-user OFDM subcarrier allocation apparatus 1100 [Tom1] provided in embodiments of the present disclosure. The apparatus can be applied to a data transmitting terminal. As shown in FIG. 11, the multi-user OFDM subcarrier allocation apparatus includes a first processing module 1101.

The first processing module 1101, configured to, according to configuration information, determine a pseudo-random subcarrier allocation manner for multi-user OFDM.

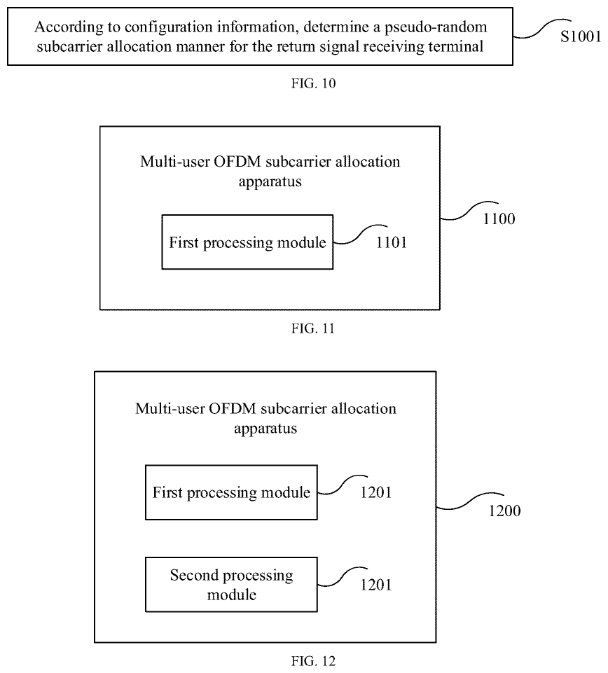

In an embodiment, as shown in FIG. 12, the multi-user OFDM subcarrier allocation apparatus 1200 may further include a second processing module 1202. The second processing module 1202, configured to, according to a number of OFDM subcarriers and a number of users, determine the configuration information. The first processing module 1201 in FIG. 12 and the first processing module 1101 in FIG. 11 have the same function and structure.

In an embodiment, the configuration information includes a position index of a subcarrier allocated to each user, and the second processing module 1202 is configured to: according to the number of OFDM subcarriers, obtaining a pseudo-random sequence output by a quadratic polynomial permutation (QPP) interleaver; and according to the pseudo-random sequence and the number of users, determining the position index of a subcarrier allocated to each user.

In an embodiment, a formula for the quadratic polynomial permutation (QPP) interleaver is represented as:

$$f ( x ) = mod ( {f}_{1} x + {f}_{2} {x}^{2} , N )$$

where N is the number of subcarriers of OFDM, N=Πₚ_{ᵢ}_{∈Γ}pᵢⁿ^{ᵢ}, Γ={2, 3, 5, 7, . . . } which is a set of prime numbers, fᵢ meets mod(f₁,pᵢ)>0; f₂ meets mod(f₂,pᵢ)>0; mod is a modular operator; x is an input sequence of the QPP interleaver, and values of the x are integers ranging from 1 to N; for any set of f₁ and f₂ that satisfy a condition, f(x) is the pseudo-random sequence output by the QPP interleaver, where values of the f(x) are integers ranging from 0 to N−1, to represent the position indexes of the subcarriers allocated to each user.

In an embodiment, according to the pseudo-random sequence and the number of users, the implementation for determining the position indexes of the subcarriers allocated to each user can be as follows: according to the number K of users, the N values in the pseudo-random sequence are sequentially divided into K groups, and the values in each group are the position indexes of the subcarriers allocated to the corresponding user, where the number of subcarriers of OFDM can be evenly divided by the number K of users, and the number of values contained in each of the K group is the same; or the number N of subcarriers of OFDM cannot be evenly divided by the number K of users, and the number of values in each of first a groups of the K groups is same, and the number of values in each of other groups is same, and the number of values in each of the first a groups is 1 more than the number of values in each of the other groups, where the a is a modular value of the number N of subcarriers of OFDM to the number K of users.

In an embodiment, the configuration information is configured by the network device or a core network device, agreed on by a protocol, or pre-configured.

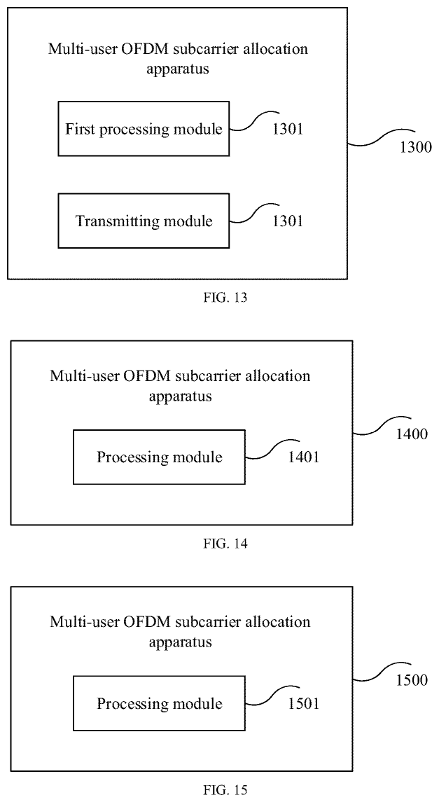

In an embodiment, as shown in FIG. 13, the multi-user OFDM subcarrier allocation apparatus 1300 may further include a transmitting module 1302. The transmitting module 1302, configured to transmit the pseudo-random subcarrier allocation manner for multi-user OFDM to a data receiving terminal and/or a return signal receiving terminal. The first processing module 1301 in FIG. 13 and the first processing module 1101 in FIG. 11 have the same function and structure.

In an embodiment, the pseudo-random subcarrier allocation manner is associated with a specific time frequency resource, where the pseudo-random subcarrier allocation manner is used on an associated time frequency resource.

In an embodiment, the pseudo-random subcarrier allocation manner used on the associated time frequency resource is fixed; or the pseudo-random subcarrier allocation manner used on the associated time frequency resource randomly changes in time-domain positions within a plurality of OFDM symbol times.

Referring to FIG. 14, FIG. 14 is a schematic diagram of a multi-user OFDM subcarrier allocation apparatus 1400 provided in embodiments of the present disclosure. The apparatus is applied to a data receiving terminal. As shown in FIG. 14, the multi-user OFDM subcarrier allocation apparatus includes a processing module 1401 for determining the pseudo-random allocation of subcarriers for the data receiving terminal according to configuration information.

In an embodiment, the configuration information is configured by a network device or a core network device, agreed on by a protocol, or pre-configured; or the configuration information is configuration information of the pseudo-random subcarrier allocation manner for multi-user OFDM transmitted by a data transmitting terminal.

In an embodiment, the configuration information includes position indexes of subcarriers allocated to each user.

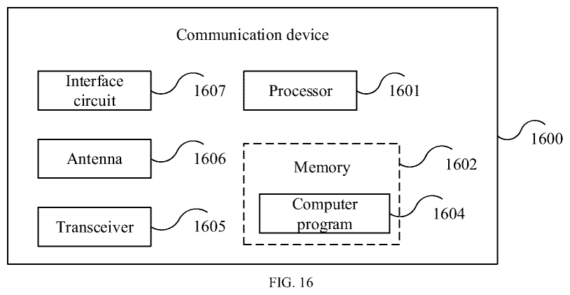

Referring to FIG. 15, FIG. 15 is a schematic diagram of a multi-user OFDM subcarrier allocation apparatus 1500 provided in embodiments of the present disclosure. The apparatus is applied to a return signal receiving terminal. As shown in FIG. 15, the multi-user OFDM subcarrier allocation apparatus includes a processing module 1501 for determining the pseudo-random allocation of subcarriers for the return signal receiving terminal according to configuration information.

In an embodiment, the configuration information is configured by a network device or a core network device, agreed on by a protocol, or pre-configured; or the configuration information is configuration information of the pseudo-random subcarrier allocation manner for multi-user OFDM transmitted by a data transmitting terminal.

In an embodiment, the configuration information includes position indexes of subcarriers allocated to each user.

By implementing the embodiments of the present disclosure, the subcarriers can be randomly allocated to users based on the pseudo-random sequence to reduce a correlation of signals from different users, thereby improving detection performance of the integrated communication radar system.

Regarding the apparatuses in the above examples, the specific manner in which each module performs operations has been described in detail in the examples of the methods, and will not be described in detail here.

Referring to FIG. 16, FIG. 16 is a schematic structural diagram of a communication device 1600 according to embodiments of the present disclosure. The communication device 1600 can be a communication device, or a chip, chip system, or processor that supports the implementation of the above method by the communication device. The communication device can be configured to implement the methods described in the above method embodiments, as described in the above method embodiments.

The communication device 1600 may include one or more processors 1601. The processor 1601 can be a general-purpose processor or a dedicated processor, etc. For example, the processor 181 can be a baseband processor or a central processing unit. The baseband processor can be used to process communication protocols and communication data, while the central processor can be used to control communication devices (such as base stations, baseband chips, electronic devices, electronic device chips, DU or CU, etc.), execute computer programs, and process computer program data.

In an embodiment, the communication device 1600 may further include one or more memories 1602, on which a computer program 1604 may be stored, and the processor 1601 may execute the computer program 1604 to enable the communication device 1600 to execute the method described in the above embodiments. In an embodiment, the memory 1602 may further store data. The communication device 1600 and memory 1602 can be set separately or integrated together.

In an embodiment, the communication device 1600 may also include a transceiver 1605 and an antenna 1606. The transceiver 1605 can be referred to as a transceiver unit, transceiver machine, or transceiver circuit, etc., used to achieve transceiver functions. The transceiver 1605 can include a receiving terminal and a transmitter, and the receiving terminal can be referred to as a receiving machine or a receiving circuit, etc., to achieve receiving functions. A transmitter can be referred to as a transmitting machine or a transmission circuit, etc., used to achieve transmission functions.

In an embodiment, the communication device 1600 may further include one or more interface circuits 1607. Interface circuit 1607 is used to receive code instructions and transmit them to processor 1601. The processor 1601 runs the code instructions to cause the communication device 1600 to execute the method described in the above method embodiment.

The communication device 1600 can be the data transmitting terminal in the aforementioned method embodiments, where the processor 1601 is configured to execute step S301 in FIG. 3 and step S401 in FIG. 4, and the transceiver 1605 is configured to perform step S501 in FIG. 5.

The communication device 1600 can be the data receiving terminal in the aforementioned method embodiments, where the processor 1601 is configured to execute step S901 in FIG. 9.

The communication device 1600 can be the return signal receiving terminal in the aforementioned method embodiments, where the processor 1601 is configured to execute step S1001 in FIG. 10.

In an embodiment, the processor 1601 may include a transceiver for implementing reception and transmission functions. For example, the transceiver can be a transceiver circuit, an interface, or an interface circuit. The transceiver circuit, interface, or interface circuit used to achieve receiving and transmitting functions can be separate or integrated together. The above-mentioned transceiver circuit, interface or interface circuit can be used for reading and writing code/data, or the above-mentioned transceiver circuit, interface or interface circuit can be used for signal transmission or transmission.

In an embodiment, the processor 1601 may store a computer program 1603. The computer program 1603 runs on the processor 1601 to enable the communication device 1600 to execute the method described in the above embodiments. The computer program 1603 may be embedded in processor 1601, where the processor 1601 may be implemented by hardware.

In an embodiment, the communication device 1600 may include a circuit that can perform the functions of transmitting, receiving, or communicating as described in the aforementioned method embodiments. The processor and transceiver described in the present disclosure can be implemented on integrated circuits (ICs), analog ICs, RF integrated circuits (RFICs), mixed signal ICs, application specific integrated circuits (ASICs), printed circuit boards (PCBs), electronic devices, or the like. The processor and transceiver can also be manufactured using various IC process technologies, such as complementary metal oxide semiconductor (CMOS), nMetal oxide semiconductor (NMOS), positive channel metal oxide semiconductor (PMOS), bipolar junction transistor (BJT), bipolar CMOS (BiCMOS), silicon germanium (SiGe), or gallium arsenide (GaAs), etc.

The communication device described in the above embodiments may be a network device or a terminal device (such as the data transmitting terminal, data receiving terminal, and return signal receiving terminal in the aforementioned method embodiments), but the scope of the communication device described in the present disclosure is not limited to this, and the structure of the communication device may not be limited by FIG. 11. The communication device can be an independent device or can be part of a larger device. For example, the communication device may be:
(1) Independent integrated circuit (IC), or a chip, or a chip system or a subsystem;
(2) A set of one or more ICs, which may optically further include a storage component for storing data or a computer program;
(3) ASICs, such as modems;
(4) Modules that can be embedded in other devices;
(5) Receiver, terminal device, intelligent terminal device, cellular phone, wireless device, handheld device, mobile unit, vehicle mounted device, network device, cloud device, or artificial intelligence device, etc;
(6) Others and so on.

Those skilled in the art can also understand that the various illustrative logical blocks and steps listed in the embodiments of the present disclosure can be implemented through electronic hardware, computer software, or a combination of both. Whether such functionality is implemented through hardware or software depends on the specific application and overall system design requirements. Those skilled in the art may use various methods to implement the described functions for each specific application, but such implementation should not be understood as exceeding the scope of protection in the embodiments of the present disclosure.

The present disclosure further provides a readable storage medium on which instructions are stored, and when the instructions are executed by a computer, the functions of any one of the above method embodiments are implemented.

The present disclosure further provides a computer program product that implements the functions of any one of the above method embodiments when executed by a computer.

The above embodiments can be fully or partially implemented through software, hardware, firmware, or any combination thereof. When implemented using software, all or part of the steps can be implemented in the form of a computer program product. The computer program product includes one or more computer programs. When loading and executing the computer program on the computer, all or part of the processes or functions described in the embodiments of the present disclosure are generated. The computer can be a general-purpose computer, a specialized computer, a computer network, or other programmable devices. The computer program can be stored in a computer-readable storage medium or transmitted from one computer-readable storage medium to another. For example, the computer program can be transmitted from one website site, computer, server, or data center to another via wired (such as coaxial cable, fiber optic, digital subscriber line (DSL)) or wireless (such as infrared, wireless, microwave, etc.) manners. The computer-readable storage medium can be any available medium that the computer can access, or a data storage device such as a server, data center, etc. that integrates one or more available media. The available medium can be a magnetic medium (such as floppy disk, hard disk, magnetic tape), optical medium (such as high-density digital video disc (DVD)), or semiconductor medium (such as solid-state disk (SSD)), etc.

Those skilled in the art can understand that the first, second, and other numerical numbers involved in the present disclosure are only for the convenience of description and differentiation, and are not used to limit the scope of the embodiments of the present disclosure, and also do not indicate sequential ordering.

“At least one” in the present disclosure can also be described as one or more, and multiple can be two, three, four, or more, without limitation in the present disclosure. In embodiments of the present disclosure, for a technical feature, the technical features described in “first,” “second,” “third,” “A,” “B,” “C,” and “D” are distinguished, and there is no sequential ordering or magnitude ordering between the technical features described in “first,” “second,” “third,” “A,” “B,” “C,” and “D.”

The corresponding relationships shown in each table in the present disclosure can be configured or predefined. The values of the information in each table are only examples and can be configured to other values, which is not limited in the present disclosure. When configuring the correspondence between information and various parameters, it is not necessary to configure all the correspondence shown in each table. For example, in the table of the present disclosure, the corresponding relationships shown in certain rows may not be configured. For example, appropriate deformation adjustments can be made according to the above table, such as splitting, merging, etc. The names of the parameters shown in the titles of the above tables can also use other names that can be understood by the communication device, and the values or representations of their parameters can also be understood by other values or representations that can be understood by the communication device. When implementing the above tables, other data structures can also be used, such as arrays, queues, containers, stacks, linear tables, pointers, linked lists, trees, graphs, structures, classes, heaps, hash tables, or hash tables.

The predefined terms in the present disclosure can be understood as defined, defined in advance, stored, pre-stored, pre-negotiated, pre-configured, solidified, or pre-fired.

Those skilled in the art can realize that the units and algorithm steps of each example described in the embodiments of the present disclosure can be implemented in electronic hardware, or a combination of computer software and electronic hardware. Whether these functions are executed in hardware or software depends on the specific application and design constraints of the technical solution. Those skilled in the art may use different methods to implement the described functions for each specific application, but such implementation should not be considered beyond the scope of the present disclosure.

Those skilled in the art can clearly understand that for the convenience and brevity of description, the specific working process of the above-described system, apparatus and unit can refer to the corresponding process in the foregoing method embodiments, which will not be repeated here.

The foregoing description is merely a specific embodiment of the present disclosure, but the scope of protection of the present disclosure is not limited thereto, and any variation or replacement readily conceivable by a person skilled in the art within the technical scope disclosed in the present disclosure should belong to the scope of protection of the present disclosure. Therefore, the scope of protection of the present disclosure should be based on the scope of protection of said claims.

1. A method for multi-user orthogonal frequency division multiplexing (OFDM) subcarrier allocation performed by a data transmitting terminal, the method comprising:
according to configuration information, determining a pseudo-random subcarrier allocation manner for multi-user OFDM.

2. The method according to claim 1, further comprising:
according to a number of subcarriers of OFDM and a number of users, determining the configuration information.

3. The method according to claim 2, wherein the configuration information comprises position indexes of subcarriers allocated to each user; and according to the number of subcarriers of OFDM and the number of users, determining the configuration information comprises:
according to the number of subcarriers of OFDM, obtaining a pseudo-random sequence output by a quadratic polynomial permutation (QPP) interleaver; and
according to the pseudo-random sequence and the number of users, determining the position indexes of the subcarriers allocated to each user.

4. The method according to claim 3, wherein a formula for the quadratic polynomial permutation (QPP) interleaver is represented as:
$$f ( x ) = mod {f}_{1} x + {f}_{2} {x}^{2} , N )$$
wherein N is the number of subcarriers of OFDM, N=Πₚ_{ᵢ}_{∈Γ}pᵢⁿ^{ᵢ}, Γ={2, 3, 5, 7, . . . }, fᵢ meets mod(f₁,pᵢ)>0; f₂ meets mod(f₂,pᵢ)>0; mod is a modular operator; x is an input sequence of the QPP interleaver, and values of the x are integers ranging from 1 to N; for any set of f₁ and f₂ that satisfy a condition, f(x) is the pseudo-random sequence output by the QPP interleaver, wherein values of the f(x) are integers ranging from 0 to N−1, to represent the position indexes of the subcarriers allocated to each user.

5. The method according to claim 4, wherein according to the pseudo-random sequence and the number of users, determining the position indexes of the subcarrier allocated to each user comprises:
according to the number K of users, sequentially dividing N values in the pseudo-random sequence into K groups, and values in each group are the position indexes of the subcarriers allocated to the corresponding user;
wherein
the number N of subcarriers of OFDM is evenly divided by the number K of users, and a number of values in each of the K groups is same; or
the number N of subcarriers of OFDM cannot be evenly divided by the number K of users, and a number of values in each of first a groups of the K groups is same, and a number of values in each of other groups is same, and the number of values in each of the first a groups is 1 more than the number of values in each of the other groups, wherein the a is a modular value of the number N of subcarriers of OFDM to the number K of users.

6. The method according to claim 1, wherein the configuration information is configured by a network device or a core network device, agreed on by a protocol, or pre-configured.

7. The method according to claim 1, further comprising:
transmitting the pseudo-random subcarrier allocation manner for multi-user OFDM to a data receiving terminal and/or a return signal receiving terminal.

8. The method according to claim 7, wherein the pseudo-random subcarrier allocation manner is associated with a specific time frequency resource, wherein the pseudo-random subcarrier allocation manner is used on an associated time frequency resource.

9. The method according to claim 8, wherein,
the pseudo-random subcarrier allocation manner used on the associated time frequency resource is fixed; or
the pseudo-random subcarrier allocation manner used on the associated time frequency resource randomly changes in time-domain positions within a plurality of OFDM symbol times.

10. A method for multi-user orthogonal frequency division multiplexing (OFDM) subcarrier allocation performed by a data receiving terminal, the method comprising:
according to configuration information, determining a pseudo-random subcarrier allocation manner for the data receiving terminal.

11. The method according to claim 10, wherein the configuration information is configured by a network device or a core network device, agreed on by a protocol, or pre-configured; or the configuration information is configuration information of the pseudo-random subcarrier allocation manner for multi-user OFDM transmitted by a data transmitting terminal.

12. The method according to claim 10, wherein the configuration information comprises position indexes of subcarriers allocated to each user.

13. A multi-user orthogonal frequency division multiplexing (OFDM) subcarrier allocation method, performed by a return signal receiving terminal, comprising:
according to configuration information, determining a pseudo-random subcarrier allocation manner for the return signal receiving terminal.

14. The method according to claim 13, wherein the configuration information is configured by a network device or a core network device, agreed on by a protocol, or pre-configured; or the configuration information is configuration information of the pseudo-random subcarrier allocation manner for multi-user OFDM transmitted by a data transmitting terminal.

15. The method according to claim 13, wherein the configuration information comprises position indexes of subcarriers allocated to each user.

16-30. (canceled)

31. A communication device, comprising one or more processors and one or more memories, wherein a computer program is stored in the one or more memories, and the one or more processors execute the computer program stored in the one or more memories to cause the communication device to execute the method according to claim 1.

32. A communication device, comprising one or more processors and one or more memories, wherein a computer program is stored in the one or more memories, and the one or more processors execute the computer program stored in the one or more memories to cause the communication device to execute the method according to claim 10.

33. A communication device, comprising one or more processors and one or more memories, wherein a computer program is stored in the one or more memories, and the one or more processors execute the computer program stored in the one or more memories to cause the communication device to execute the method according to claim 13.

34. A non-transitory computer-readable storage medium storing instructions, wherein when the instructions are executed, the method according to claim 1 is implemented.

35. A non-transitory computer-readable storage medium storing instructions, wherein when the instructions are executed, the method according to claim 10 is implemented.

36-39. (canceled)
